(19) United States
(12) Patent Application Publication
(10) Pub. No.: US 2022/0410348 A1
(43) Pub. Date: Dec. 29, 2022

(54) SHOT PROCESSING SYSTEM AND SHOT PROCESSING METHOD

(71) Applicant: SINTOKOGIO, LTD., Nagoya-shi (JP)

(72) Inventors: Akinori MATSUI, Nagoya-shi (JP); Yuji KOBAYASHI, Nagoya-shi (JP)

(73) Assignee: SINTOKOGIO, LTD., Nagoya-shi (JP)

(21) Appl. No.: 17/848,484

(22) Filed: Jun. 24, 2022

(30) Foreign Application Priority Data
Jun. 29, 2021 (JP) 2021-107803

(51) Int. Cl. B24C 7/00; B24C 1/10; G01N 29/14; G01N 29/04; G01N 29/22; G01N 29/44

(52) U.S. Cl. CPC B24C 7/0015; B24C 1/10; G01N 29/14; G01N 29/045; G01N 29/22; G01N 29/4418

(57) ABSTRACT

A shot processing system according to an aspect includes a shot processing apparatus to project shot media, a measurement device output a signal waveform related to a wave generated due to collision of the shot media, a control device to control the shot processing apparatus. The control device includes a processing condition acquisition unit to acquire a required intensity, a control unit to control the shot processing apparatus to cause the shot processing apparatus to perform the shot processing to the measurement device under a first shot condition, an intensity analysis unit to acquire a measured intensity by analyzing the signal waveform output by the shot processing to the measurement device, and a correction unit to correct a shot condition of the shot processing apparatus from the first shot condition to a second shot condition to reduce a difference between the required intensity and the measured intensity.

### CROSS-REFERENCE TO RELATED APPLICATIONS

This application is based on and claims the benefit of priority from Japanese Patent Application No. 2021-107803 filed on Jun. 29, 2021, the entire contents of which are incorporated herein by reference.

### TECHNICAL FIELD

The present disclosure relates to a shot processing system and a shot processing method.

### BACKGROUND

Shot processing apparatuses that project shot media onto a processing object (workpiece) are used in shot processing such as shot blasting and shot peening. In such a shot processing using a shot processing apparatus, it is necessary to cause the shot media to collide with the processing object at an appropriate intensity to allow the processing object to become an appropriate processed state in light of its use.

Some of known examples in terms of a method for measuring shot intensity for the shot media include the technology described in Patent Literature 1. According to Patent Literature 1. an elastic wave generated.

due to shot media collision with a disk is converted into a high-frequency electric signal, and the high-frequency electric signal is analyzed to acquire a counter output voltage and a peak voltage. Based on the acquired counter output voltage and peak voltage, a shot collision amount and kinetic energy are detected.

### PRIOR ART DOCUMENT

### Patent Literature

Patent Literature 1: Japanese Unexamined Patent Application Publication No. 04-019071

### SUMMARY

An apparatus described in Patent Literature 1 adjusts a projection amount of the shot media and shot intensity by changing a shot condition of the shot processing apparatus. Since there are various parameters for the shot condition for shot processing, for example, shot media projection pressure, the amount of the shot media projected, the type (particle diameter and hardness) of the shot media, the distance from the nozzle to the processing object, and the diameter of the nozzle, selecting one particular appropriate shot condition to process the processing object with a desired intensity s not an easy task. When an appropriate shot condition is not set, the processing object cannot be processed with the desired intensity.

In light of above, there is a need to determine an appropriate shot condition to process a processing object at the desired intensity

A shot processing apparatus according to an aspect includes a shot processing apparatus, a measurement device, and a control device. The shot processing apparatus performs shot processing to project the shot media. The measurement device receives the shot media projected from the shot processing apparatus and outputs a signal waveform related to a wave generated due to collision of the shot media. The control device controls the shot processing apparatus. The control device includes a processing condition acquisition unit, a control unit, an intensity analysis unit, and a correction unit. The processing condition acquisition unit acquires a required intensity indicating an intensity of shot processing to be performed on a processing object. The control unit controls the shot processing apparatus to cause the shot processing apparatus to perform the shot processing to the measurement device under a first shot condition. The intensity analysis unit acquires a measured intensity indicating an intensity of the shot processing to the measurement device by analyzing the signal waveform output from the measurement device in response to the shot processing performed to the measurement device. The correction unit corrects the shot condition of the shot processing apparatus from the first shot condition to a second shot condition to reduce a difference between the required intensity and the measured intensity.

In the shot processing system of this aspect, when shot media is projected from the shot processing apparatus to the measurement device under the first shot condition, a signal waveform related to a wave generated due to collision of the shot media is output from the measurement device. By analyzing this signal waveform, the measured intensity indicating the intensity of the shot processing to the measurement device is acquired. Then, the first shot condition is corrected to the second shot condition to reduce the difference between the required intensity and the measured intensity. This correction allows the shot condition of the shot processing apparatus to become closer to the shot condition for the required intensity. Thus, this aspect makes it possible to determine an appropriate shot condition to process the processing object at the required intensity.

In another aspect, provided is a shot processing method with a shot processing system including a shot processing apparatus that performs shot processing to project shot media. The shot processing method includes acquiring a required intensity indicating an intensity of the shot processing to be performed on a processing object, causing the shot processing to be performed from the shot processing apparatus to a measurement device under a first shot condition, acquiring a signal waveform related to a wave generated in response to collision of the shot media with the measurement device, acquiring a measured intensity indicating an intensity of the shot processing to the measurement device by analyzing the signal waveform, and correcting a shot condition of the shot processing apparatus from the first shot condition to a second shot condition to reduce a difference between the required intensity and the measured intensity.

As described above, with the shot processing method according to this aspect, the shot condition of the shot processing apparatus can be made closer to the shot condition for the required intensity. It is thus possible to determine an appropriate shot condition for processing the processing object with the required intensity.

According to various aspects of the present disclosure, an appropriate shot condition to process the processing object at a desired intensity can be determined.

### BRIEF DESCRIPTION OF THE DRAWINGS

FIG. 1 is a schematic diagram illustrating a shot processing system according to an embodiment.

FIG. 2 is a block diagram illustrating a functional configuration of a shot processing system.

FIG. 3 is a diagram illustrating an example of an AE signal waveform measured by an AE sensor.

FIG. 4 is a graph illustrating a relationship between an AE parameter and an intensity.

FIG. 5 is a graph showing a relationship between an AE parameter and an injection pressure of shot media.

FIG. 6 is a flowchart illustrating a shot processing method according to an embodiment.

FIG. 7 is a flowchart illustrating a method for monitoring an abnormality of a shot processing apparatus.

### DETAILED DESCRIPTION

An embodiment of the present disclosure will now be described with reference to the drawings, in the following description, the same or corresponding elements are denoted by the same reference numerals, and redundant description is not repeated. The dimensional ratios in the drawings are not necessarily consistent with those in the description.

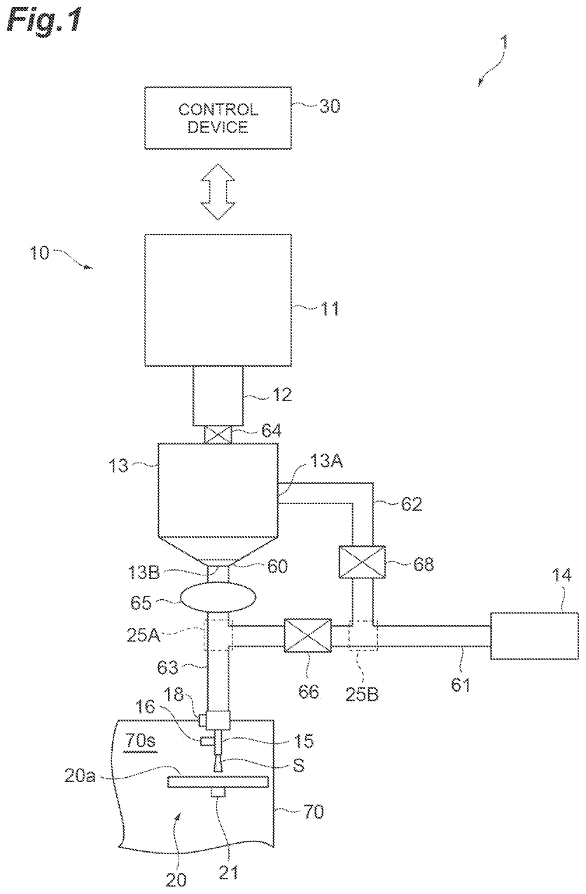

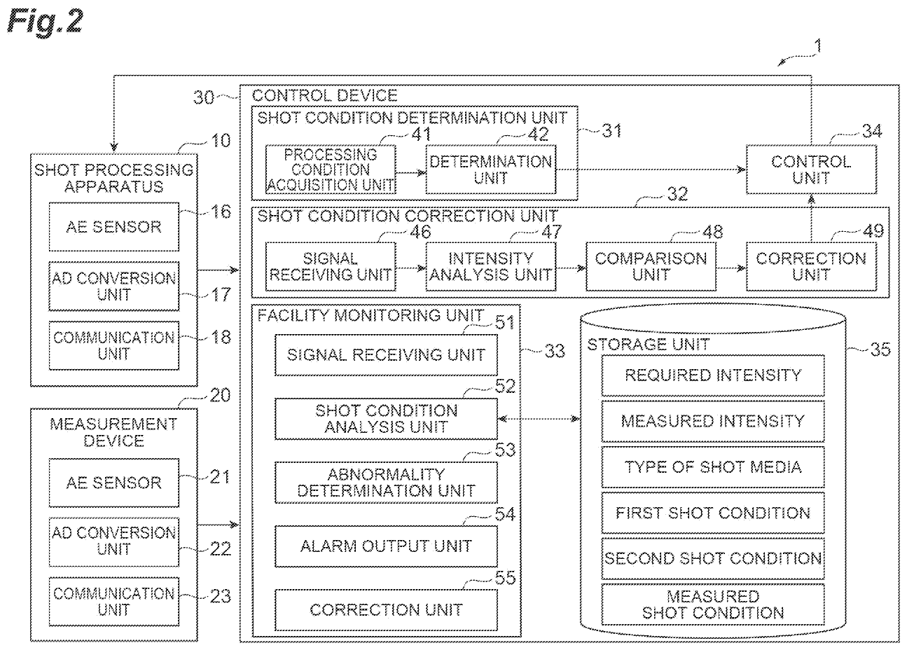

FIG. 1 is a schematic diagram illustrating a shot processing system according to an embodiment. FIG. 2 is a block diagram illustrating a functional configuration of the shot processing system according to an embodiment. The shot processing system 1 in FIGS. 1 and 2 determines a shot condition for shot media to enable a processing object to be processed at a desired intensity, and projects the shot media at the determined shot condition. As used herein and the appended claims, the term “shot processing” means a process of projecting the shot media from the shot processing apparatus. Shot processing includes shot blasting for scale removal, debarring, and surface roughness adjustment, and shot peening for imparting residual compressive stress to the processing object.

As illustrated in FIG. 1, the shot processing system 1 includes a shot processing apparatus 10, a measurement device 20, and a control device 30. The shot processing apparatus 10 projects the shot media onto the processing object and causes the shot media to collide with the processing object to process a surface of the processing object. For example, the shot processing apparatus 10 may be a shot peening apparatus that applies compressive residual stress to the surface of the processing object. Examples of the processing object on which shot processing is performed by the shot processing apparatus 10 include but are not limited to automobile parts such as cylinder heads and crankshafts, gears, and molds. Applying the compressive residual stress to the surface of the processing object with the shot processing improves fatigue characteristics of the processing object. The magnitude of the compressive residual stress to be applied to the processing object is determined in light of use of the processing object. The magnitude of the compressive residual stress applied to the processing object depends on the intensity of shot processing (collision intensity of the shot media).

The shot processing apparatus 10 shown in FIG. 1 is a direct pressure type shot peening apparatus. The shot processing apparatus 10 may be a suction-type or gravity-type shot peening apparatus. Shot media S projected onto the processing object may be steel balls. The grain size of a steel ball is appropriately selected according to the compressive residual stress to be applied to the processing object.

As in FIG. 1. the shot processing apparatus 10 includes a shot media tank 11, a shot media supply device 12, a pressurized tank 13, a compressor 14, and a nozzle 15. The shot media tank 11 stores the shot media S, and is connected to the pressurized tank 13 via the shot media supply device 12. A poppet valve 64, which is openable and closable, is provided between the shot media supply device 12 and the pressurized tank 13, When the poppet valve 64 opens, the shot media S stored in the shot media tank 11 is supplied to the pressurized tank 13 via the shot media supply device 12.

The compressor 14 generates compressed air, and supplies the compressed air to the pressurized tank 13 and the nozzle 15. One end of a pipe 61 is connected to the compressor 14. The other end of the pipe 61 is connected to a pipe 63 to be described later. A pipe 62 is branched from a position between one end and the other end of the pipe 61. The pipe 62 is connected to an air inlet 13A of the pressurized tank 13. The pipe 62 is provided with an air flow rate regulating valve 68. The air flow rate regulating valve 68 regulates the flow rate of the compressed air flowing through the pipe 62. When the air flow rate regulating valve 68 opens, the compressed air from the compressor 14 is supplied to the pressurized tank 13 via the pipe 61 and the pipe 62. When the compressed air is supplied from the compressor 14 to the pressurized tank 13, pressurization occurs in the pressurized tank 13.

The pressurized tank 13 has a shot outlet 13B through which shot media S flows out. The shot outlet 13B is provided with a cut gate 60, which is openable and closable. A pipe 63 is connected to the shot outlet 13B via the cut gate 60. The pipe 63 is provided with a shot amount adjustment valve 65 that adjusts the amount of the shot media S projected from the nozzle 15. The other end of the pipe 61 is connected to the pipe 63. A portion where the pipe 61 is connected with the pipe 63 constitutes a mixing portion 25A in which the shot media S supplied from the pressurized tank 13 is mixed with the compressed air supplied from the compressor 14. The mixing portion 25A is located downstream in the flow direction of the compressed air relative to a branch portion 25B where the pipe 62 branches from the pipe 61.

An air flow rate regulating valve 66 is provided at a position between the mixing portion 25A and the branch portion 25B in the pipe 61. The air flow rate regulating valve 66 regulates the flow rate of the compressed air supplied from the compressor 14 to the nozzle 15. The compressed air with the flow rate regulated by the air flow rate regulating valve 66 is mixed with the shot media S supplied from the pressurized tank 13 in the mixing portion 25A, and is sent to the nozzle 15.

The nozzle 15 is provided at a distal end of the pipe 63, and ejects the shot media S supplied from the pressurized tank 13 together with the compressed air as a gas-solid two phase flow. The nozzle 15 is disposed inside a cabinet 70. The cabinet 70 defines a processing chamber 70s which is a space for processing the processing object. To perform shot processing on the processing object, the processing object is disposed in the processing chamber 70s, and the shot media S is projected from the nozzle 15 toward the processing object in the processing chamber 70s so that the shot media S collides with the processing object.

Although not illustrated in FIG. 1, the shot processing apparatus 10 may further include a dust collector, a classifier, and a circulator to enable reuse of used shot media S. The dust collector is connected to the processing chamber 70s via the classifier. The dust collector suctions the shot media S and debris of the processing object that have fallen to the lower portion of the processing chamber 70s and transfers the suctioned shot media S and the debris to the classifier. The classifier may be of a cyclone type. The classifier receives the shot media S and the debris of the processing object, and separates grains reusable as the shot media S and grains non-reusable as the shot media S. The circulator returns the reusable shot media S to the shot media tank 11 via, for example, a packet elevator, a screw conveyor, and a separator.

The shot processing apparatus 10 further includes an AE sensor (second AE sensor) 16, an AD conversion unit 17, and a communication to unit 18 (see FIG. 2). The AE sensor 16 is fixed to the nozzle 15, measures acoustic emission (AE) generated when the shot media S is projected from the nozzle 15 of the shot processing apparatus 10, and outputs a signal waveform related to the measured AE (hereinafter referred to as “AE signal waveform”). The AE signal waveform is a signal waveform related to an elastic wave such as vibration and a sound wave generated when the projected shot media S passes through the nozzle 15. The AE signal waveform includes, for example, an amplitude, a duration, an AE count, a rise time, an AE count rate, and an average frequency as characteristic parameters related to the intensity of the shot processing.

The AD conversion unit 17 converts the AE signal waveform output from the AE sensor 16 into digital data and outputs the digital data. The communication unit 18 is a communication module capable of wireless communication such as LAN, Bluetooth (registered trademark), and Wi-Fi. The communication unit 18 receives the digital data of the AE signal waveform measured by the AE sensor 16 from the AD conversation unit 17, and transmits the digital data to the control device 30 by wireless communication.

As described above, the shot media S projected from the nozzle 15 of the shot processing apparatus 10 collides with the processing object. When the shot media S collides with a surface of the processing object, a force that extends the surface of the processing object acts thereon. This generates a reaction force against the extending force on the processing object, and compressive residual stress is applied to the processing object. The magnitude of the compressive residual stress to be applied to the processing object is determined in light of use of the processing object. In order to apply the compressive residual stress appropriate for the processing object, shot processing is to be performed on the processing object at an appropriate intensity. In the following description, the term “intensity” is used as an index that quantitatively represents intensity of the shot processing. The intensity is equivalent to an arc height when a rate of increase of the arc height read from a peening time-arc height saturation curve becomes within 10%. The peening time-arc height saturation curb is prepared by performing shot processing on a test piece for a certain period of time and then measuring an arc height value. In the following description, the term “required intensity” means an intensity to apply a required magnitude of compressive residual stress to the processing object. That is, the required intensity represents the intensity of shot processing to be performed on the processing object.

In the shot processing system 1, before performing shot processing on the processing object, the intensity of the shot processing is measured by performing shot processing on the measurement device 20 to verify whether the intensity of the shot processing matches the required intensity. Further, whether the measured intensity matches the required intensity is periodically verified. The intensity may be measured once or more than once before shot processing of the processing object.

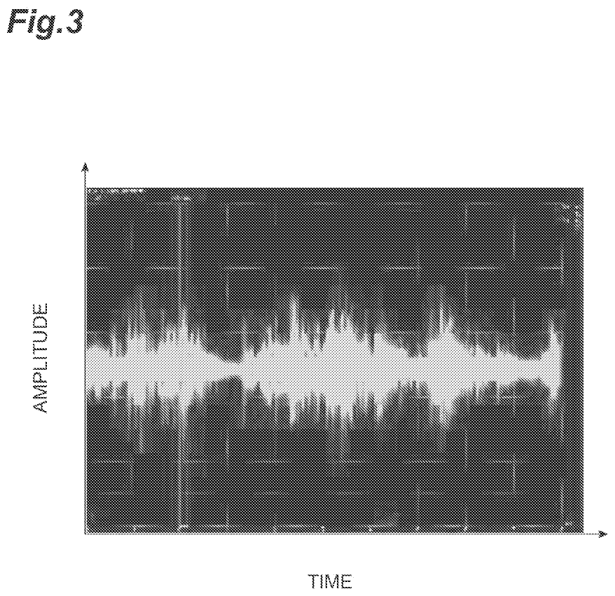

The measurement device 20 receives the shot media S projected from the shot processing apparatus 10 at a projection surface 20a, and outputs a signal related to a wave generated by the collision of the shot media S. The wave is a generic term for waves generated due to collision of the shot media S with the projection surface 20a. and is a concept that includes an elastic wave, vibrations, an ultrasonic wave, and an electromagnetic wave. As illustrated in FIG. 2, the measurement device 20 includes an AE sensor 21, an AD conversion unit 22, and a communication unit 23. The AE sensor 21 measures an AE generated due to collision of the shot media S projected from the shot processing apparatus 10 with the projection surface 20a of the measurement device 20, and outputs a signal waveform related to the measured AE. FIG. 3 indicates an example of an AE signal waveform measured by the AE sensor 21 upon collision of the shot media S. The AE signal waveform is a signal waveform related to an AE (elastic wave) generated due to collision of the shot media S with the projection surface 20a.

The AD conversion unit 22 converts the AE signal waveform output from the AE sensor 21 into digital data and outputs the digital data. The communication unit 23 is a communication module capable of wireless communication such as LAN, Bluetooth (registered trademark), and Wifi. The communication unit 23 receives the digital data of the AE signal waveform measured by the AE sensor 21 from the AD conversion unit 22, and transmits the digital data to the control device 30 by wireless communication.

The control device 30 is a computer including a processor, a storage device, an input device, a display device, and a communication device, and controls overall operation of the shot processing system 1. For example, the control device 30 loads a program stored in the storage device and cause the processor to execute the loaded program to implement various functions described below. An operator can input commands or the like with the input device of the control device 30 to control the shot processing apparatus 10. The operation state of the shot processing apparatus 10 is displayed and visualized by the display device.

The control device 30 is communicably connected to the shot processing apparatus 10 and the measurement device 20. The control device 30 determines a shot condition for the shot media S of the shot processing apparatus 10 and controls the shot processing apparatus 10 to allow the shot media S to be projected under the determined shot condition. The shot condition is a condition set in the shot processing apparatus 10 for projection of the shot media S, and includes an injection pressure and an injection amount of the shot media S.

As illustrated in FIG. 2, the control device 30 includes a shot condition determination unit 31, a shot condition correction unit 32, a facility monitoring unit 33, a control unit 34, and a storage unit 35 as functional elements. The shot condition determination unit 31 determines a shot condition for acquiring the required intensity using the correlation between the shot condition of the shot media S and the intensity.

The shot condition determination unit 31 includes a processing condition acquisition unit 41 and a determination unit 42. The processing condition acquisition unit 41 acquires the required intensity of the processing object as a processing condition. In addition to the required intensity, the processing condition acquisition unit 41 may acquire an intensity management range and information on shot media (particle diameter, hardness, etc.). These processing conditions may be input by the operator of the shot processing apparatus 10 or may be stored in the storage unit 35 in advance. The processing condition acquisition unit 41 stores the acquired processing condition in the storage unit 35.

The determination unit 42 determines a shot condition for acquiring the required intensity based on the processing condition of the processing object acquired by the processing condition acquisition unit 41. The shot condition of the shot processing apparatus 10 and the intensity are correlated, and a model equation representing the correlation between the shot condition of the shot processing apparatus 10 and the intensity is stored in the storage unit 35 of the control device 30 in advance. The determination unit 42 determines the first shot condition as the shot condition corresponding to the required intensity having been acquired by the processing condition acquisition unit 41 using the model equation stored in the storage unit 35. The determination unit 42 stores the determined first shot condition in the storage unit 35.

The control unit 34 controls the shot processing apparatus 10 such that shot media is projected under the first shot condition determined by the shot condition determination unit 31. For example, the control unit 34 controls the operation of the compressor 14 of the shot processing apparatus 10, the opening and closing of the cut gate 60, the opening degree of the shot amount adjustment valve 65, and the opening degrees of the air flow rate regulating valve 66 and the air flow rate regulating valve 68 to enable projection of the shot media S from the shot processing apparatus 10 at the projection pressure and the projection amount set in the first shot condition. The shot media S projected from the shot processing apparatus 10 collides with the projection surface 20a of the measurement device 20. The measurement device 20 measures AE caused due to the collision of shot media S and outputs the AE signal waveform.

The shot condition correction unit 32 analyzes the AE signal waveform measured by the measurement device 20 to acquire a measured value of intensity (hereinafter referred to as “measured intensity”), and corrects the shot condition of the shot processing apparatus 10 based on a difference between the measured intensity and the required intensity. As in FIG. 2, the shot condition correction unit 32 includes a signal receiving unit 46, an intensity analysis unit 47, a comparison unit 48, and a correction unit 49. The signal receiving unit 46 receives digital data of the AE signal waveform measured by the AE sensor 21 from the communication unit 23.

The intensity analysis unit 47 analyzes the AE signal waveform received by the signal receiving unit 46 and calculates the intensity when the shot processing is performed under the first shot condition. For example, the intensity analysis unit 47 acquires an AE parameter from the AE signal waveform. The AE parameter may be the amplitude, duration, AE count, or risetime of the AE signal waveform. A peak value, an average value, or an effective value of the AE signal waveform may also be used as the AE parameter.

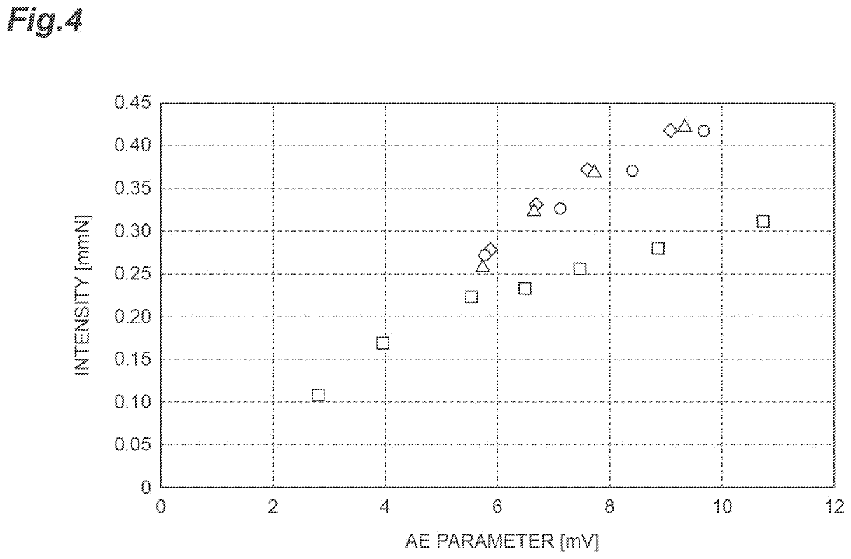

FIG. 4 is a graph in which the relationship between the AE parameter and the intensity is plotted by shot media type. As in FIG. 4, the AE parameter and the intensity are correlated. The intensity analysis unit 47 draws an approximate straight line or an approximate curve representing the relationship between the AE parameter and the intensity of the shot processing as in the graph of FIG. 4, and generates a model equation representing the correlation between the AE parameter and the to shot processing for each type of shot media from the approximate straight line or the approximate curve. Then, the intensity analysis unit 47 calculates the intensity corresponding to the AE parameter of the AE signal waveform received by the signal receiving unit 46 based on the generated model equation. The intensity calculated in this manner is the measured intensity obtained from the measurement value of the measurement device 20. The intensity analysis unit 47 stores the measured intensity in the storage unit 35.

The comparison unit 48 compares the required intensity with the measured intensity, determines whether or not the difference between the required intensity and the measured intensity is within a specified management range, and outputs information indicating the determination result to the correction unit 49.

When the comparison unit 48 determines that the difference between the required intensity and the measured intensity does not fall within the specified management range, the correction unit 49 corrects the shot condition of the shot processing apparatus 10 from the first shot condition to a second shot condition to reduce the difference between the required intensity and the measured intensity. For example, the intensity of the shot processing tends to increase as the injection pressure or the injection amount of the shot media S increases. Thus, when the measured intensity is smaller than the required intensity, for example, the correction unit 49 sets the second shot condition in which the injection pressure or the injection amount is greater than the injection pressure or the injection amount designated by the first shot condition. Then, the correction unit 49 stores the second shot condition that is the corrected shot condition in the storage unit 35.

The control unit 34 controls the shot processing apparatus 10 to cause the shot media S to be projected onto the processing object under the second shot condition corrected by the correction unit 49. Projecting the shot media S under the second shot condition allows the intensity of the shot processing to become closer to the required intensity. This enables the desired compressive residual stress to be applied to the processing object.

The facility monitoring unit 33 detects an abnormality of the shot processing apparatus 10 and includes, as in FIG. 2, a signal receiving unit 51, a shot condition analysis unit 52, an abnormality determination unit 53, an alarm output unit 54, and a correction unit (second correction unit) 55. The signal receiving unit 51 receives digital data of an AE signal waveform measured by the AE sensor 16 of the shot processing apparatus 10 from the communication unit 18.

The shot condition analysis unit 52 analyzes the AE signal waveform received by the signal receiving unit 51 and acquires a shot condition of the shot processing apparatus 10 when the shot media S is projected. First, the shot condition analysis unit 52 acquires an AE parameter from the AE signal waveform.

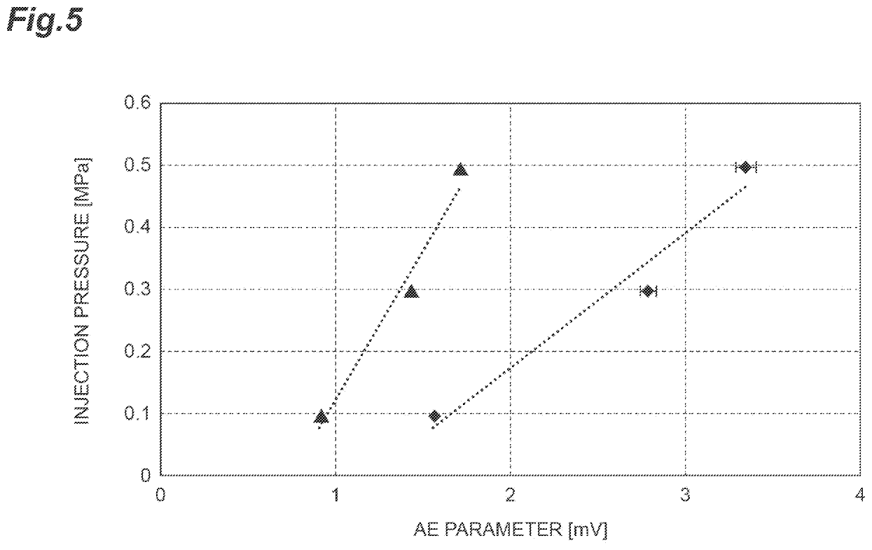

FIG. 5 is a graph in which the relationship between the AE parameter and the injection pressure of shot media S, which is one of the shot conditions, is plotted for each type of shot media. As in FIG. 5, the injection pressure and the AE parameter are correlated. The shot condition analysis unit 52 draws an approximate straight line or an approximate curve representing the relationship between the injection to pressure and the AE parameter as in the graph of FIG. 5, and generates a model equation representing the correlation between the injection pressure and the AE parameter from the approximate straight line or the approximate curve fir each type of shot media. Then, the intensity analysis unit 47 calculates an injection pressure (shot condition) corresponding to the AE parameter of the AE signal waveform received by the signal receiving unit 51 based on the generated model equation. The shot condition analysis unit 52 may calculate the injection amount corresponding to the AE parameter of the AE signal waveform received by the signal receiving unit 51 based on a model equation representing the correlation between the injection amount of the shot media. S and the AE parameter. The shot condition calculated in this manner is a measured value of the shot condition calculated from the measured value of the AE sensor 21 (hereinafter referred to as “measured shot condition”). The shot condition analysis unit 52 stores the measurement shot condition calculated in the storage unit 35.

The abnormality determination unit 53 compares a shot condition (for example, the first shot condition or the second shot condition) set in the shot processing apparatus 10 (hereinafter referred to as “set shot condition”) with the measured shot condition. When there is a difference between the set shot condition and the measured shot condition, a defect such as a hole in the pipe of the shot processing apparatus 10 may have occurred, which may have caused a deviation of the actual shot condition of the shot processing apparatus 10 from the set shot condition. Thus, when the difference between the set shot condition and the measured shot condition exceeds a predetermined threshold value, the abnormality determination unit 53 outputs abnormality detection information to the alarm output unit 54 to indicate that an abnormality has occurred in the shot processing apparatus 10. Upon receiving the abnormality detection information from the abnormality determination unit 53, the alarm output unit 54 outputs an alarm. Any form may be used as the output form of the alarm as long as the alarm can be notified to the operator of the shot processing apparatus 10. The alarm output unit 54 may visually display information indicating the occurrence of an abnormality on the display device of the control device 30, or may transmit information indicating the occurrence of an abnormality to a computer terminal of the operator. These enable early notification of the abnormality of the shot processing apparatus 10 to the operator of the shot processing apparatus 10.

The correction unit 55 corrects the shot condition of the shot processing apparatus 10 in response to an output of the abnormality detection information from the abnormality determination unit 53. For example, when the injection pressure of the measured shot condition is smaller than the injection pressure of the set shot condition, the injection pressure of the set shot condition is increased. This allows the actual shot condition of the shot processing apparatus 10 to become closer to the target shot condition. In the embodiment illustrated in FIG. 2, the facility monitoring unit 33 includes both the alarm output unit 54 and the correction unit 55, but the facility monitoring unit 33 may include only one of the alarm output unit 54 and the correction unit 55.

As described above, in the shot processing system 1 according to the above-described embodiment, when the shot media S is projected from the shot processing apparatus 10 to the measurement device 20 under the first shot condition, an AE signal waveform generated due to collision of the shot media S is output from the measurement device 20. The measured intensity is then calculated by analyzing the AE signal waveform, and the shot condition of the shot processing apparatus 10 is corrected from the first shot condition to the second shot condition to reduce the difference between the required intensity and the measured intensity. Performing shot processing on the processing object under the corrected second shot condition enables to apply of the desired compressive residual stress to the processing object.

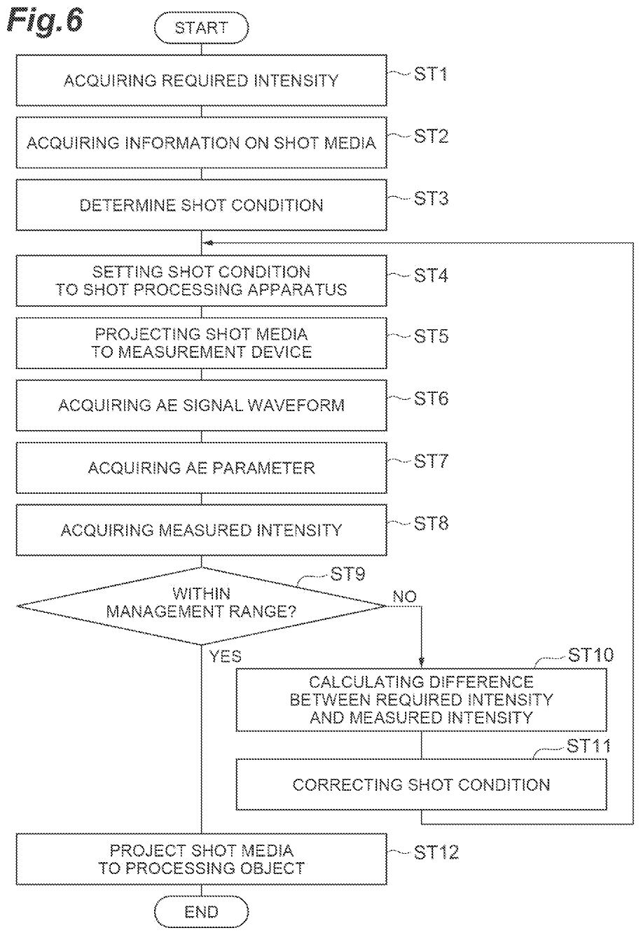

Next, a shot processing method of the processing object using the above-described shot processing system 1 will be described. FIG. 6 is a flowchart illustrating a shot processing method according to an embodiment.

In this method, the processing condition acquisition unit 41 of the control device 30 firstly acquires the required intensity (step ST1). The required intensity may be input by an operator of the shot processing apparatus 10, or information stored in advance in the storage unit 35 may be read. In step ST1, an allowable range (tolerance) of the intensity may be acquired in addition to the required intensity.

Next, the processing condition acquisition unit 41 acquires information related to the shot media S (step ST2). The information on the shot media may include the particle size and hardness of the shot media S. Next, the determination unit 42 determines the shot condition of the shot processing apparatus 10 based on the required intensity and the information on the shot media (step ST3). The shot condition of the shot processing apparatus 10 may include an injection pressure and an injection amount of the shot media S. The determination unit 42 may determine the first shot condition corresponding to the required intensity using a model equation representing the correlation between the shot condition of the shot processing apparatus 10 and the intensity

Next, the first shot condition is set in the shot processing apparatus 10 (step ST4). The first shot condition may be manually input by an operator using an input device, or may be set by causing the control unit 34 to transmit the determined first shot condition to the shot processing apparatus 10.

Next, the shot processing apparatus 10 projects the shot media S under the first shot condition onto the measurement device 20 disposed in the processing chamber 70s (step ST5). The shot media S projected from the shot processing apparatus 10 collides with the projection surface 20a of the measurement device 20. The measurement device 20 measures an elastic wave generated due to collision of the shot media S and transmits an AE signal waveform related to the measured elastic wave to the control device 30 by wireless communication. The signal receiving unit 46 acquires the AE signal waveform output from the AE sensor 21 of the measurement device 20 (step ST6).

Next, the intensity analysis unit 47 analyzes the AE signal waveform to acquire an AE parameter (step ST7). Further, the intensity analysis unit 47 acquires the measured intensity corresponding to the AE signal waveform acquired in step ST6 using a model equation representing the correlation between the AE parameter and the intensity (step ST8).

Next, the comparison unit 48 compares the required intensity acquired in step ST1 with the measured intensity calculated in step ST8, and determines whether the difference between the measured intensity and the required intensity falls within the management range (step ST9). That is, when the measured intensity is equal to or less than the upper limit value of the management range of the required intensity and equal to or more than the lower limit value of the management range of the required intensity, the comparison unit 48 determines that the difference between the measured intensity and the required intensity is within the management range. When it is determined that the measured intensity outside of the management range, the correction unit 49 calculates a difference between the required intensity and the measured intensity (step ST10).

Next, the correction unit 49 corrects the shot condition to reduce the difference between the required intensity and the measured intensity (step ST11). For example, when the measured intensity is smaller than the required intensity, the shot condition of the shot processing apparatus 10 is corrected to a second shot condition in which an injection pressure or an injection amount is greater than the injection pressure or the injection amount of the first shot condition. A greater difference between the required intensity and the measured intensity leads to a greater correction of the injection pressure or the injection amount.

Next, the corrected second shot condition is set in the shot processing apparatus 10 (step ST4), and the shot processing apparatus 10 projects the shot media S to the measurement device 20 under the corrected second shot condition (step ST5). Then, steps ST4 to ST11 are repeated until the difference between the measured intensity and the required intensity falls within the management range.

When the measured intensity falls within the management range, the measurement device 20 is taken out from the processing chamber 70s, and the processing object is placed in the processing chamber 70s. Then, the shot processing apparatus 10 projects the shot media S onto the processing object under the set shot condition (step ST12). Thus, the shot processing of the required intensity is performed on the processing object. As a result, a desired compressive residual stress is applied to the processing object.

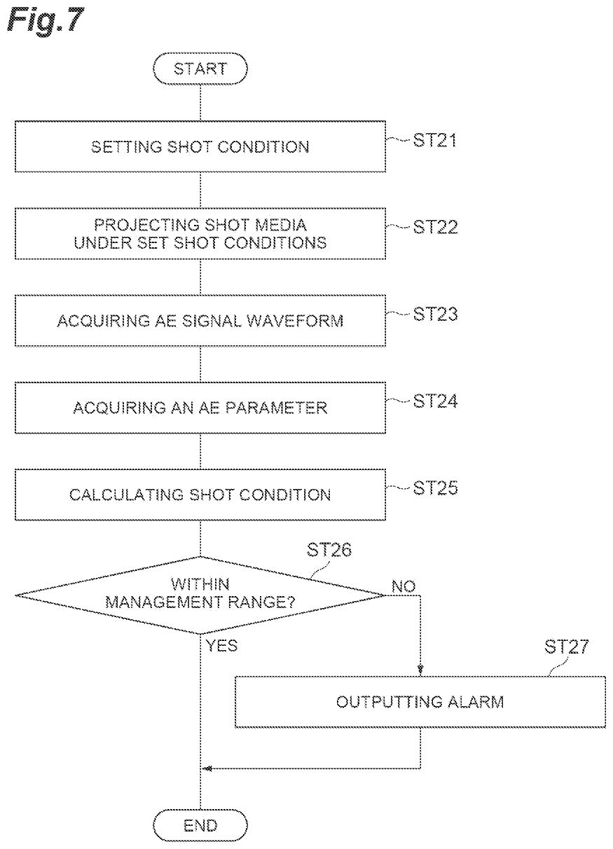

Next, a method of monitoring an abnormality of the shot processing apparatus 10 will be described with reference to FIG. 7. Illustrated in FIG. 7 is a flowchart indicating a method of monitoring an abnormality of the shot processing apparatus 10. The method in FIG. 7 may be executed in parallel with the shot processing method in FIG, 6,

In this method, first, a shot condition is set in the shot processing apparatus 10 (step ST21). The shot condition set in step ST21 may be the first shot condition determined by the shot condition determination unit 31 or may be the second shot condition corrected by the shot condition correction unit 32. Next, the shot processing apparatus 10 projects the shot media S under the set shot condition (step ST22). At this time, when the shot media S passes through the nozzle 15 of the shot processing apparatus 10, an elastic wave such as a sound wave and vibrations is generated around the nozzle 15.

Next, the AE sensor 16 of the shot processing apparatus 10 measures the elastic wave generated when the shot media S is projected, and outputs an AE signal waveform related to the measured elastic wave. The signal receiving unit 51 acquires the AE signal waveform output from the AE sensor 16 (step ST23). Next, the shot condition analysis unit 52 analyzes the AE signal waveform received by the signal receiving unit 51 and acquires an AE parameter corresponding to the AE signal waveform (step ST24). Next, the shot condition analysis unit 52 calculates a shot condition corresponding to the AE signal waveform using a model equation representing the correlation between the AE parameter and the shot condition (step ST25). The shot condition calculated in step ST25 is a measured shot condition calculated from the measurement value of the AE sensor 21.

Next, the abnormality determination unit 53 compares the set shot condition set in step ST21 with the measured. shot condition calculated in step ST25, and determines whether the difference between the set shot condition and the measured shot condition is within an allowable range (step ST26). When the difference between the set shot condition and the measured shot condition is equal to or less than a predetermined threshold value, the abnormality determination unit 53 determines that the difference is within the allowable range. When the difference between the set shot condition and the measured shot condition is within the allowable range, the shot processing apparatus 10 is determined to be in normal operation, and the series of processes ends.

On the other hand, when the difference between the set shot condition and the measured shot condition exceeds the predetermined threshold value, the abnormality determination unit 53 outputs abnormality detection information. In response to the output of the abnormality detection information, the alarm Output unit 54 Outputs an alarm (step ST27). This alarm output enables early notification of the abnormality of the shot processing apparatus 10 to the operator of the shot processing apparatus 10.

When the abnormality determination unit 53 outputs the abnormality detection information, the correction unit 55 may correct the shot condition of the shot processing apparatus 10. For example, when the injection pressure calculated in step ST25 is smaller than the injection pressure set in step ST21, the actual injection pressure of the shot processing apparatus 10 is made closer to the target injection pressure by increasing the injection pressure of the shot processing apparatus 10.

Although the shot processing system and shot processing method have been described in accordance with various embodiments above, the present invention is not limited to the above-described embodiments, and various modifications may be devised without departing from the scope of the present invention.

For example, in the shot processing system 1 in FIG. 2, the control device 30 includes the facility monitoring unit 33 that detects an abnormality of the shot processing apparatus 10, but the control device 30 does not necessarily include the facility monitoring unit 33. Including at least the shot condition determination unit 31 and the shot condition correction unit 32 enables determining a shot condition for performing shot processing on the processing object with the required intensity.

In addition, in the above-described embodiment, the shot condition analysis unit 52 of the facility monitoring unit 33 calculates the measurement shot condition by analyzing the AE signal waveform output from the AE sensor 16, but the AE signal waveform from the AE sensor 16 may not necessarily be used as long as the measurement shot condition can be calculated. As described above, the shot condition of the shot processing apparatus 10 and the intensity are correlated. Therefore, in one embodiment, the measured shot condition may be calculated from the measured intensity calculated by the intensity analysis unit 47 using the correlation between the shot condition of the shot processing apparatus 10 and the intensity. Then, the set shot condition may be compared with the measured shot condition calculated from the measured intensity, and the abnormality detection information may be output when the difference between the two shot conditions exceeds a predetermined threshold value. In this embodiment, an abnormality of the shot processing apparatus 10 can be detected without using the AE sensor 16, which leads to a reduced number of components in the shot processing system 1.

In the above-described embodiment, the shot peening apparatus that applies compressive residual stress to the processing object is used as the shot processing apparatus 10. However, the shot processing apparatus 10 is not limited to the shot peening apparatus as long as the apparatus can project shot media. For example, the shot processing apparatus 10 may be a shot blasting apparatus that projects shot media onto the processing object to remove burrs or adjust surface roughness. Further, the shot processing apparatus 10 according to the above-described embodiment is an air nozzle type shot peening apparatus that ejects the shot media S by compressed air, but in one embodiment, the shot processing apparatus 10 may be an impeller type shot peening apparatus that projects the shot media S by centrifugal force of an impeller rotating at high speed. In this case, the impeller rotation speed is included in the shot condition.

In the above-described embodiment, the measurement device 20 measures the elastic wave caused due to the collision of the shot media with the projection surface 20a using the AE sensor. However, the measurement device 20 may measure waves other than the elastic wave and output a signal waveform related to the waves, Examples of sensors that measure waves other than the elastic wave include a vibration sensor, an accelerometer, and an impact sensor that measure vibrations, an ultrasonic sensor that measures ultrasonic waves, an electromagnetic sensor that measures electromagnetic waves, an eddy-current sensor, a laser displacement meter or an ultrasonic sensor that measures displacements, a color sensor that measures colors, and a Barkhausen noise sensor that measures Barkhausen noise.

It should be noted that the various embodiments described above can be combined to the extent that no contradiction is caused.

### REFERENCE SIGNS LIST

1: shot processing system, 10: shot processing apparatus, 15: nozzle, 16: AE sensor (second AE sensor), 20: measurement device, 20a: projection surface, 21: AE sensor, 30: control device, 34: control unit, 47: intensity analysis unit, 49: correction unit, 52: shot condition analysis unit, 54: alarm output unit, 55: correction unit (second correction unit), S: shot media.

What is claimed is:

1. A shot processing system comprising:
a shot processing apparatus that performs shot processing to project shot media;
a measurement device to receive the shot media projected from the shot processing apparatus and output a signal waveform related to a wave generated due to collision of the shot media; and
a control device to control the shot processing apparatus, wherein the control device includes a processing condition acquisition unit to acquire a required intensity indicating an intensity of the shot processing to be performed on a processing object, a control unit to control the shot processing apparatus to cause the shot processing apparatus to perform the shot processing to the measurement device under a first shot condition, an intensity analysis unit to acquire a measured intensity indicating an intensity of the shot processing to the measurement device by analyzing the signal waveform output from the measurement device in response to the shot processing performed to the measurement device, and a correction unit to correct a shot condition of the shot processing apparatus from the first shot condition to a second shot condition to reduce a difference between the required intensity and the measured intensity.

2. The shot processing system according to claim 1, wherein the control device further includes a determination unit to determine the first shot condition based on the required intensity.

3. The shot processing system according to claim 1, wherein the measurement device includes:
a projection surface to receive the shot media; and
an AE sensor to output the signal waveform related to an elastic wave generated due to collision of the shot media with the projection surface.

4. The shot processing system according to claim 1,
wherein the shot processing apparatus further includes a second AE sensor fixed to a nozzle of the shot processing apparatus, wherein the second AE sensor is configured to measure an elastic wave generated when the shot media is projected and output the signal waveform related to the measured elastic wave, and
wherein the control device further includes a shot condition analysis unit to measure a shot condition of the shot processing apparatus by analyzing the signal waveform output from the second AE sensor.

5. The shot processing system according to claim 4, wherein the control device further includes an alarm output unit to output an alarm when a difference between a shot condition set in the shot processing apparatus by the control unit and a shot condition measured by the shot condition analysis unit exceeds a predetermined threshold.

6. The shot processing system according to claim 5, wherein the control device further includes a second correction unit to correct the set shot condition when a difference between the set shot condition and the measured shot condition exceeds a predetermined threshold value.

7. A shot processing method with a shot processing system including a shot processing apparatus that performs a shot processing to project shot media, the method comprising:
acquiring a required intensity indicating an intensity of the shot processing to be performed on a processing object;
causing the shot processing apparatus to performed the shot processing to a measurement device under a first shot condition;
acquiring a signal waveform related to a wave generated in response to collision of the shot media with the measurement device;
acquiring a measured intensity indicating an intensity of the shot processing to the measurement device by analyzing the signal waveform; and
correcting a shot condition of the shot processing apparatus from the first shot condition to a second shot condition to reduce a difference between the required intensity and the measured intensity.
